(19) United States
(12) Patent Application Publication
(10) Pub. No.: US 2008/0250442 A1
(43) Pub. Date: Oct. 9, 2008

(54) TELEVISION RECEPTION CONTROL SYSTEM

(75) Inventors: Kentaro SAITO, Osaka (JP); Kenji SHIOYAMA, Kyoto (JP)

Correspondence Address: DICKINSON WRIGHT PLLC, 1901 L STREET NW, SUITE 800, WASHINGTON, DC, 20036, US

(73) Assignee: MATSUSHITA ELECTRIC INDUSTRIAL CO., LTD., Osaka (JP)

(21) Appl. No.: 12/062,441

(22) Filed: Apr. 3, 2008

(30) Foreign Application Priority Data
Apr. 4, 2007 (JP) 2007-098334

(51) Int. Cl. H04H 60/32

(52) U.S. Cl. 725/14

(57) ABSTRACT

In a television reception control system, a master reception device receives and plays back broadcast data from a cable television network, and communicates with a slave reception device via an in-home network. The slave reception device receives and plays back the broadcast data from the cable television network, and communicates with the master reception device via the in-home network, and when no connection with the master reception device is established for a predetermined period of time, the slave reception device is suspended from receiving the broadcast data.

### FIELD OF THE INVENTION

The present invention relates to a system for controlling restrictions on reception of television broadcasting.

### BACKGROUND OF THE INVENTION

One of the services provided by cable television service providers is to provide television broadcasting to users via a cable television network. In one form of this service, the service providers rent a required number of reception terminals to each user, so that the user is allowed to view television broadcasting on a plurality of reception terminals.

This service form imposes a high fee upon the user to rent a plurality of reception terminals because the user is charged by the number of reception terminals. To encourage use of more than one reception terminal, some cable television service providers introduce contract systems in which the rental fee is kept low from the second reception terminal onward. Incidentally, the reception terminals employ a reception scheme protected by CAS (conditional access system), thereby allowing TV viewing within the broadcast coverage area of the same service provider by connecting to a cable television circuit.

A possible problem of the above service form is unfair use of a plurality of reception terminals under contract with the same user. For example, a user lends one of two rental reception terminals to his/her neighbor, and splits the rental fee for the two reception terminals between them, so that the rental fee per household is kept low compared to the case where the user and the neighbor rent one reception terminal each.

Cable television service providers do not allow the aforementioned unfair use of reception terminals, and desire to achieve usage restrictions on the second and subsequent reception terminals, in particular, viewing prohibition outside subscribers' houses. However, cable television service providers cannot determine whether two reception terminals are installed in the same house, and therefore a problem arises that no measures for preventing unfair use are available. To solve this problem, there has been proposed a technology of controlling viewing restrictions between the reception terminals using a wireless connection means (see Japanese Laid-Open Patent Publication No. 2004-312505).

FIG. 8 illustrates the configuration of reception terminals for which the aforementioned wireless connection means is used to control viewing restrictions therebetween. Digital television broadcast receivers 101 and 102, which act as a control device and a controlled device, respectively, are each provided with a wireless communication means conforming to Bluetooth or suchlike in order to allow the digital television broadcast receiver 101 to collectively control viewing restrictions on a plurality of digital television broadcast receivers 102. Accordingly, it is possible to eliminate the necessity of setting viewing restrictions or suchlike in each digital television broadcast receiver, thereby making it possible to simplify operations, as well as to collectively manage all digital television viewing information.

However, the above-described reception terminals have a problem in that viewing restrictions on the digital television broadcast receivers 102 acting as controlled devices cannot be controlled when the digital television broadcast receiver 101 is turned off, or when there is a communication failure due to radio interference.

### BRIEF SUMMARY OF THE INVENTION

In view of the above problems, the present invention aims to provide a television reception control system capable of controlling viewing restrictions on any digital television broadcast receivers acting as controlled devices, even when a digital television broadcast receiver acting as a control device is turned off or experiences a communication failure.

To achieve the above object, the present invention provides a television reception control system, comprising:

a master reception device; and

a slave reception device,

wherein the master reception device is connected to a cable television network and an in-home network so as to receive and play back broadcast data transmitted from a cable television broadcast station via the cable television network, and communicate with the slave reception device via the in-home network, and

wherein the slave reception device is connected to the cable television network and the in-home network so as to receive and play back the broadcast data transmitted from the cable television broadcast station via the cable television network, and communicate with the master reception device via the in-home network, and when no communication with the master reception device is established, the slave reception device is suspended from receiving the broadcast data.

According to the present invention, the slave reception device monitors whether communication with the master reception device is established, and suspends the television viewing function when the communication with the master reception device is disconnected. By so controlling viewing restrictions on the slave reception device, it becomes possible to restrict unfair use of the slave reception device.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is an overall system configuration diagram illustrating a television reception control system according to a first embodiment of the present invention, which is adapted to cable television broadcasting.

FIG. 2 is a block diagram illustrating the configuration of the television reception control system shown in FIG. 1.

FIG. 3 is an overall system configuration diagram illustrating the television reception control system shown in FIG. 1 having a slave reception device installed in a non-subscriber house, in association with a cable television broadcast station.

FIG. 4 is a flowchart illustrating the procedure of monitoring unfair use of the slave reception device shown in FIG. 1.

FIG. 5 is an overall system configuration diagram illustrating a television reception control system according to a second embodiment of the present invention, which is adapted to cable television broadcasting.

FIG. 6 is a block diagram illustrating the configuration of the television reception control system shown in FIG. 5.

FIG. 7 is a flowchart illustrating the procedure of monitoring unfair use of the slave reception device shown in FIG. 5.

FIG. 8 is a block diagram illustrating the configuration of conventional digital television broadcast reception devices.

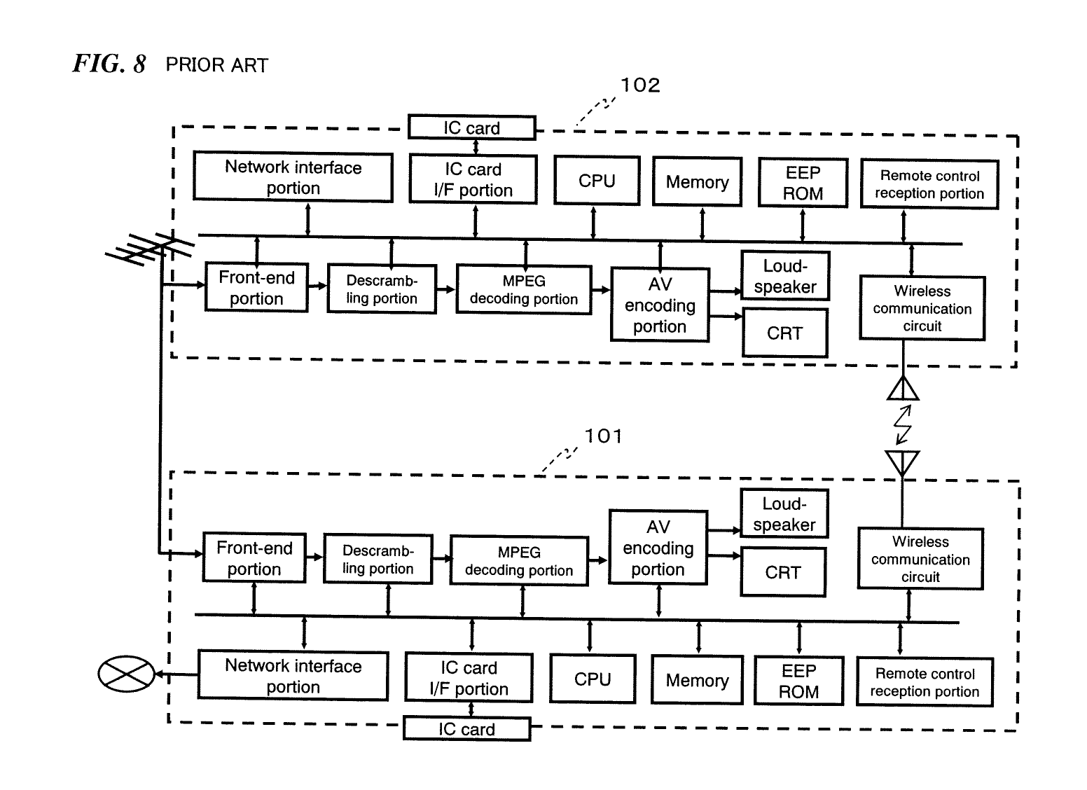

### DETAILED DESCRIPTION OF THE INVENTION

### First Embodiment

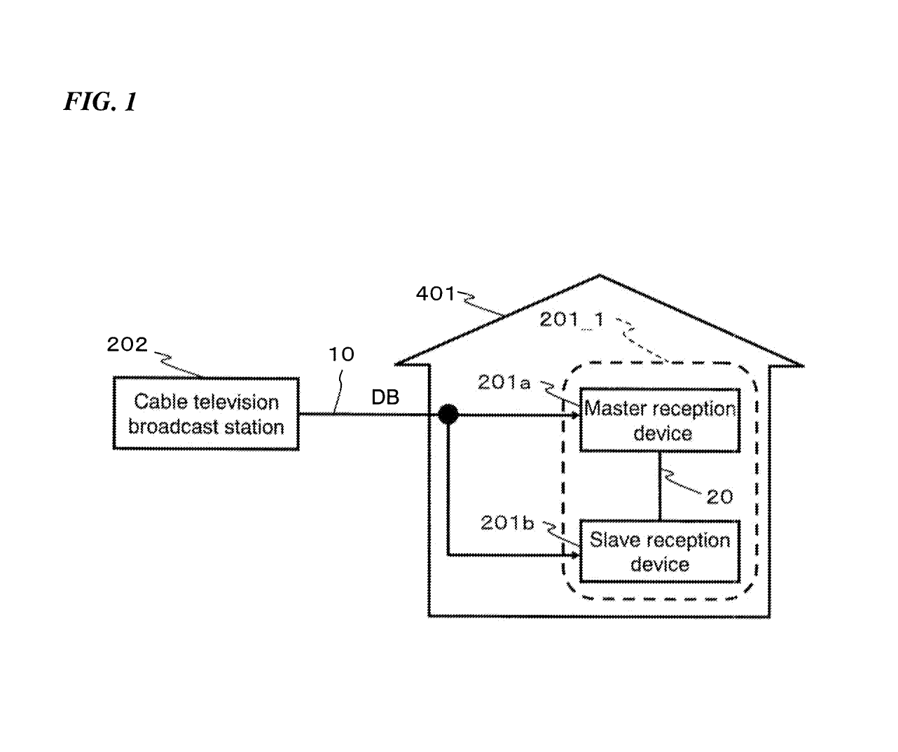

Hereinafter, a television reception control system according to a first embodiment of the present invention will be described with reference to FIGS. 1, 2, and 3. The television reception control system 201_1 is connected to a cable television broadcast station 202 via a cable television network 10, as shown in FIG. 1. The television reception control system 201_1 includes a master reception device 201a and a slave reception device 201b. The master reception device 201a and the slave reception device 201b are mutually connected via a LAN (local area network) 20, and respectively correspond to the first rental reception terminal and the second or subsequent rental reception terminal in the above-described cable television service form.

The master reception device 201a and the slave reception device 201b are connected to the cable television broadcast station 202 via the cable television network 10. In addition, the master reception device 201a and the slave reception device 201b receive broadcast data DB transmitted from the cable television broadcast station 202, and play back contents distributed in the form of the broadcast data DB. Moreover, the master reception device 201a and the slave reception device 201b are mutually connected via an in-home network constructed by the LAN 20. When connected to the master reception device 201a via the LAN 20, the slave reception device 201b is basically allowed to enable its function of receiving and playing back the broadcast data from the cable television broadcast station 202.

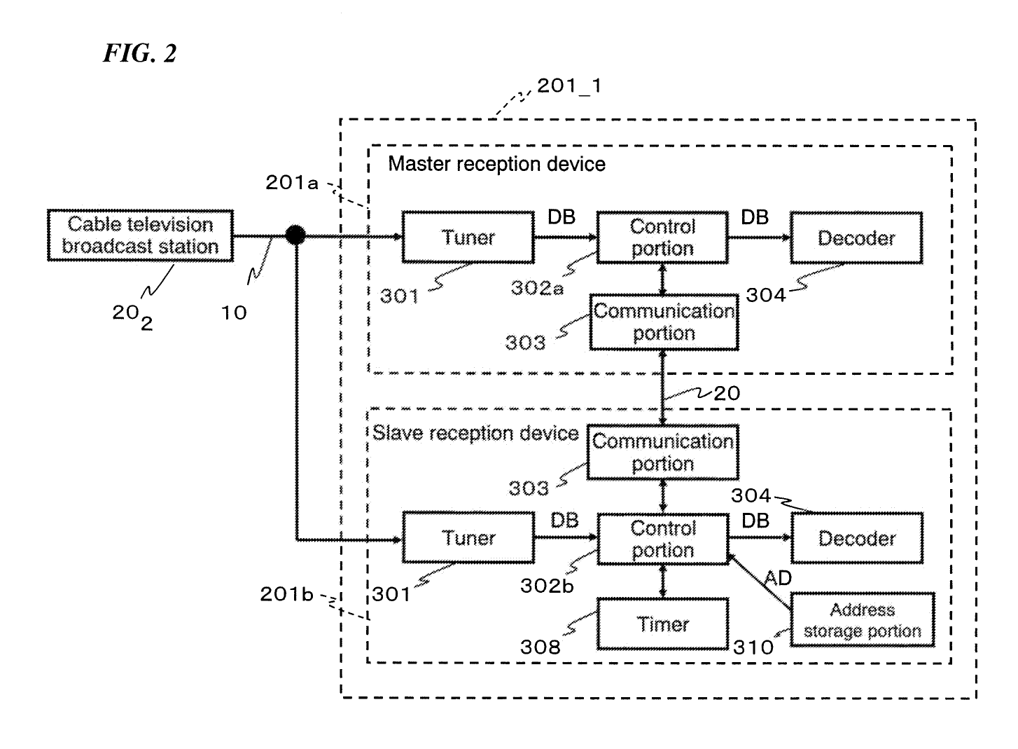

Next, the master reception device 201a and the slave reception device 201b included in the television reception control system 201_1 will be described with reference to FIG. 2. The master reception device 201a includes a tuner 301, a control portion 302a, a communication portion 303, and a decoder 304. The tuner 301 transfers broadcast data DB received from the cable television broadcast station 202 to the control portion 302a. The control portion 302a transfers the broadcast data DB received from the tuner 301 to the decoder 304. In addition, the control portion 302a communicates with the slave reception device 201b via the communication portion 303.

In order to carry out packet communication according to MAC (media access control) layer standards, the communication portion 303 has a MAC address AD stored therein, and communicates with other devices via the LAN 20. The decoder 304 decodes the broadcast data DB inputted from the control portion 302a, and displays video based on the decoded broadcast data DB.

The slave reception device 201b includes a control portion 302b, in place of the control portion 302a of the master reception device 201a, and additionally includes a timer 308 and an address storage portion 310. The address storage portion 310 has stored therein the MAC address AD of the communication portion 303 in the master reception device 201a. The timer 308 measures elapsed time, and is operated with power supplied from its internal battery even after the slave reception device 201b is turned off. The timer 308 starts measuring elapsed time and performs a reset to 0 value under control of the control portion 302b.

Similar to the control portion 302a, the control portion 302b communicates with the master reception device 201a via the communication portion 303. During communication, the control portion 302b confirms whether the communication destination (the master reception device 201a) has the MAC address AD stored in the address storage portion 310, and if the communication destination does not have the MAC address AD, the control portion 302b activates the timer 308.

When the value of the timer 308 (hereinafter, referred to as the “timer value T”) reaches a predetermined value (hereinafter, referred to as a “predetermined timer value Tₚ₁”), the control portion 302b suspends the tuner 301. When communication with the master reception device 201a is confirmed while the timer 308 is active, the control portion 302b resets the timer value T to 0. A possible example of the predetermined timer value Tₚ₁ is forty-eight hours. This is based on the assumption that, even if the master reception device 201a were turned off, so that the slave reception device 201b cannot confirm communication, the master reception device 201a would be turned on at least once every other day. Note that it is understood that the predetermined timer value Tₚ₁ can also be suitably set to any value other than forty-eight hours.

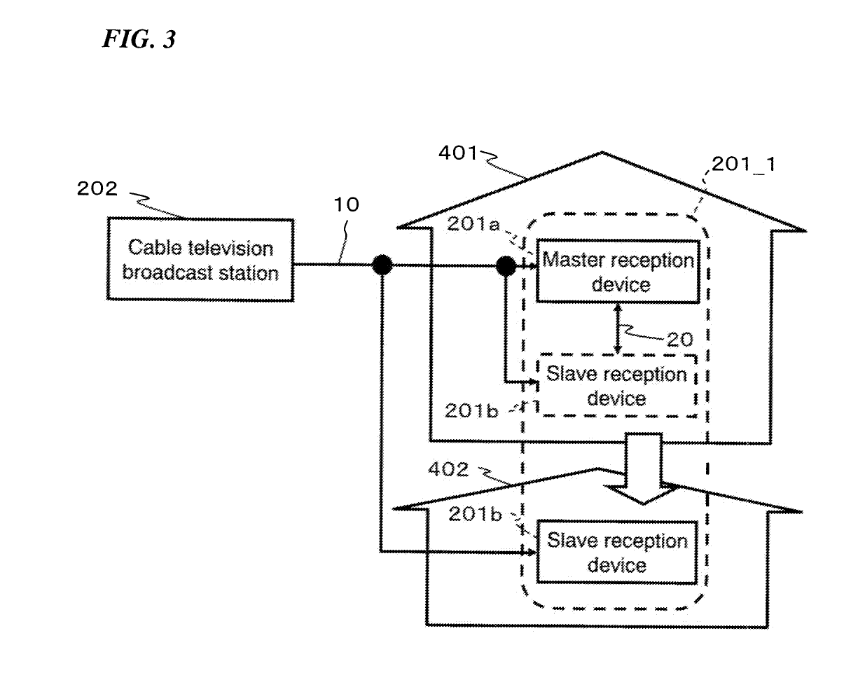

Referring to FIG. 3, the system status will be described with respect to the case where the slave reception device 201b is installed in a neighboring house (hereinafter, referred to as the “non-subscriber house 402”) to the subscriber's house (hereinafter, referred to as the “subscriber house 401”). Under contract with the cable television broadcast service provider, the slave reception device 201b is originally installed in the subscriber house 401, and connected to the cable television broadcast station 202 via the cable television network 10, as indicated by dotted lines in the figure. Furthermore, the slave reception device 201b is also connected to the master reception device 201a via the LAN 20.

When the slave reception device 201b is installed in the non-subscriber house 402, the slave reception device 201b is connected to the cable television broadcast station 202 via the cable television network 10 as in the subscriber house 401. However, the slave reception device 201b is not connected to the master reception device 201a installed in the subscriber house 401 via the LAN 20. That is, the slave reception device 201b is not connected to the communication portion 303 of the master reception device 201a that has the MAC address AD stored therein via the LAN 20.

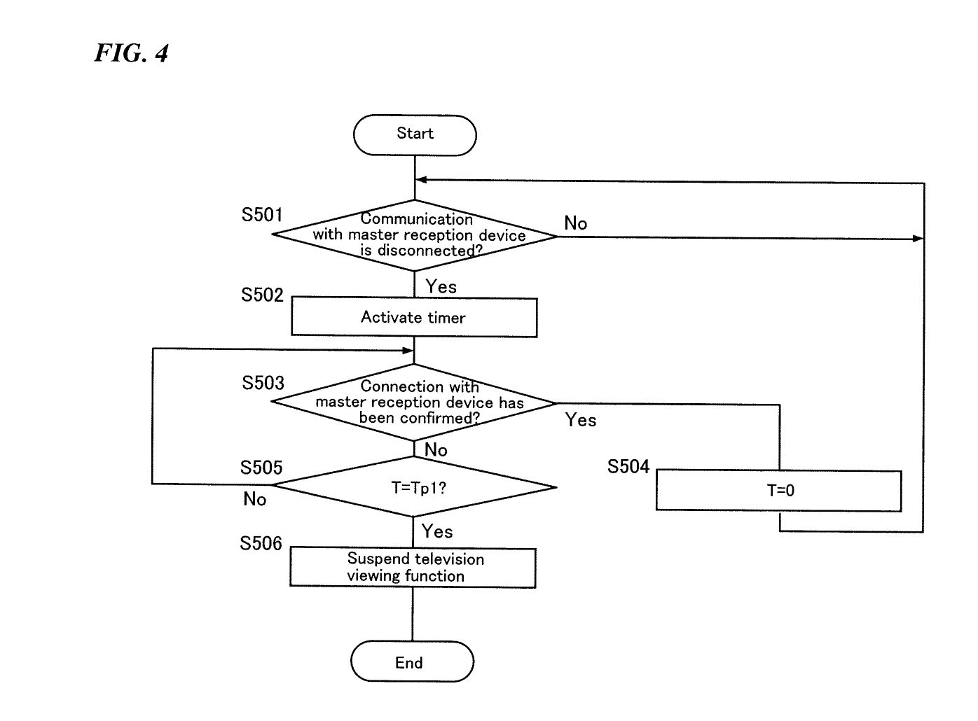

Referring to FIG. 4, control by the slave reception device 201b installed in another house as described above will be described, mainly focusing on the control operation by the control portion 302b. When the slave reception device 201b is turned on, the slave reception device 201b starts operating.

First, in step S501, the slave reception device 201b determines whether communication with the master reception device 201a via the LAN 20 is disconnected. When the communication is determined to be disconnected, control advances to the next step S502.

In step S502, the timer 308 is activated. That is, measurement of the timer value T is started. Then, control advances to step S503.

In step S503, connection of the slave reception device 201b with the master reception device 201a is confirmed while the timer is operating. After the connection has been confirmed, if communication between the slave reception device 201b and the master reception device 201a is established, the determination “Yes” is made, and control advances to step S504.

In step S504, the timer 308 is reset (i.e., the timer value T is set to 0). Then, control returns to the above step S501.

On the other hand, if the connection is not confirmed in step S503, i.e., the determination “No” is made, control advances to step S505.

In step S505, a determination is made, regarding whether the timer value T has reached the predetermined timer value Tₚ₁. Control advances to the next step S506 only when the determination “Yes” is made.

In step S506, the tuner 301 is suspended, so that the television viewing function is suspended. Then, control is terminated.

As described above, if the slave reception device 201b is installed in the non-subscriber house 402, it is possible to impose viewing restrictions on the slave reception device 201b being unfairly used by monitoring whether the communication between the slave reception device 201b and the master reception device 201a is established. Note that it is assumed that even when the master reception device 201a and the slave reception device 201b are properly installed in the same subscriber house 401, the communication between the slave reception device 201b and the master reception device 201a cannot be established for some reason, e.g., the master reception device 201a is turned off. In such a case, viewing restrictions are falsely imposed on the slave reception device 201b even though it is being properly used.

Even under such a situation, if the communication between the slave reception device 201b and the master reception device 201a can be confirmed before the timer value T of the timer 308 reaches the predetermined timer value Tₚ₁, the cable television broadcasting can be viewed without any viewing restrictions being imposed on the slave reception device 201b. Concretely, in the present embodiment, the predetermined timer value Tₚ₁ is set at forty-eight hours, and therefore if the master reception device 201a is turned on within forty-eight hours, the user can view the cable television broadcasting without any inappropriate viewing restrictions being imposed on the slave reception device 201b being properly used. As such, the predetermined timer value Tₚ₁ is suitably set in accordance with the user's usage state, making it possible to prevent any inappropriate viewing restrictions on the proper user.

### Second embodiment

Characteristics unique to a television reception control system according to a second embodiment of the present invention will be described first in comparison to the television reception control system according to the first embodiment. The television reception control system 201_1 according to the first embodiment is configured on the assumption that it is provided with a timer for measuring elapsed time after power off. However, some recent television reception devices do not have any timer for measuring elapsed time after power off, and therefore it is not possible to realize the television reception control system 201_1 because it imposes viewing restrictions using the timer. Accordingly, proposed as the second embodiment of the present invention is a television reception control system capable of imposing viewing restrictions based on time lapse during which no connection is made with the master reception device 201a, even in the case of using such a television reception device without any timer.

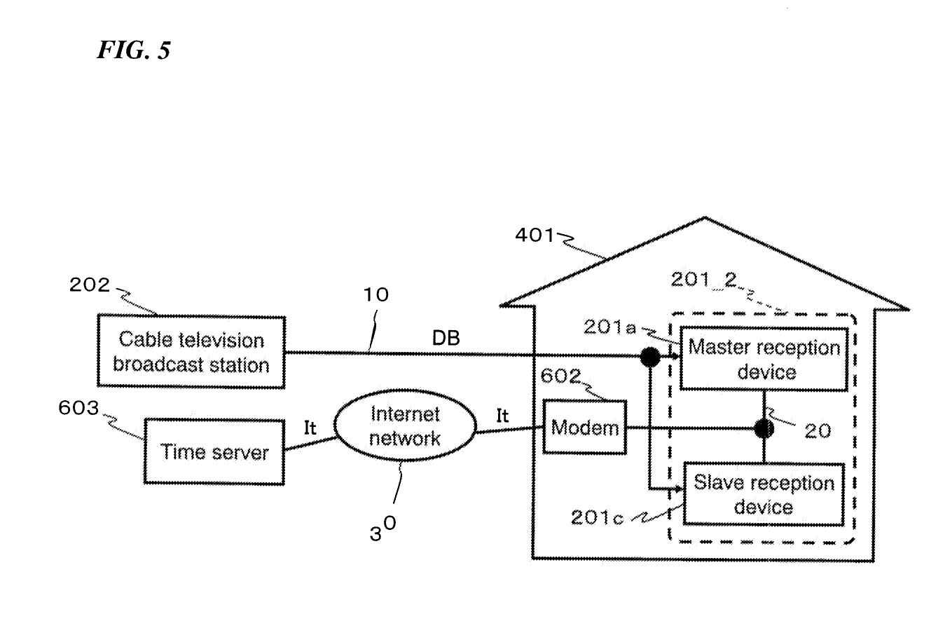

Referring to FIGS. 5, 6, and 7, the television reception control system according to the present embodiment will be described in detail below. The television reception control system 201_2 according to the present embodiment includes a slave reception device 201c, in place of the slave reception device 201b of the television reception control system 201_1, as shown in FIG. 5. In addition, the master reception device 201a and the slave reception device 201c are connected to a time server 603 via the LAN 20, a modem 602, and an internet network 30.

When connected to the master reception device 201a, the slave reception device 201c is allowed to enable its function of receiving and playing back broadcast data DB from the cable television broadcast station 202. In addition, the master reception device 201a and the slave reception device 201c acquire time information It from the time server 603 via the modem 602 and the internet network 30.

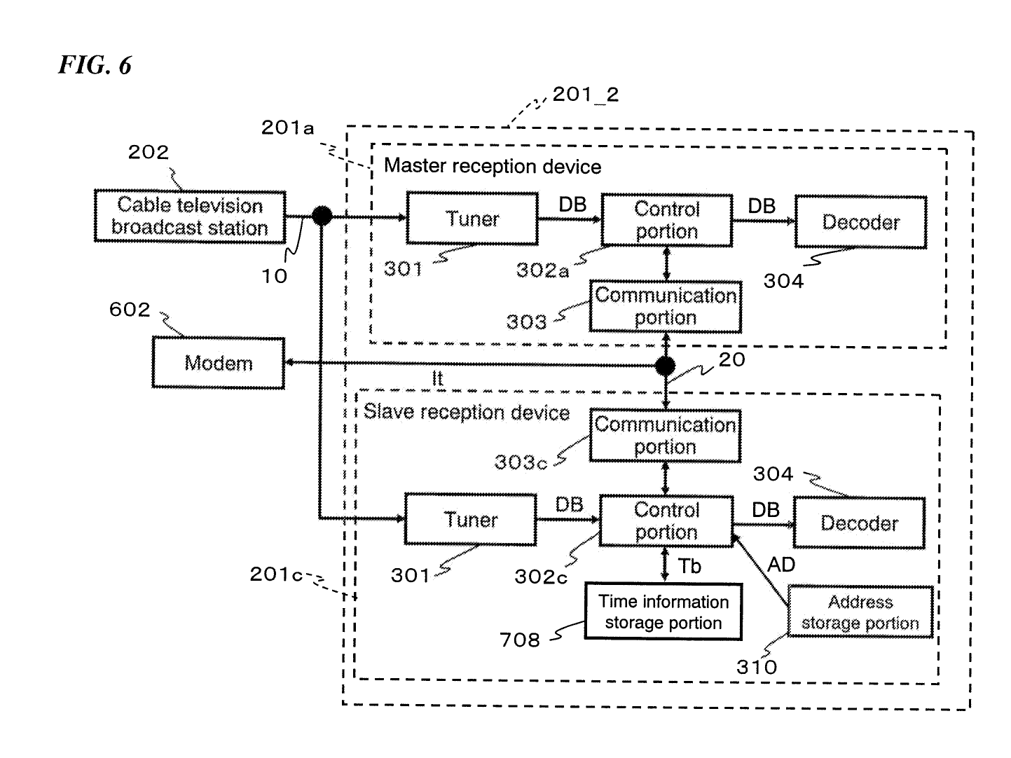

Next, referring to FIG. 6, the slave reception device 201c of the television reception control system 201_2 will be described. Note that the master reception device 201a has already been described, and therefore the description thereof will be omitted here. The slave reception device 201c includes a control portion 302c, a communication portion 303c, and a time information storage portion 708, in place of the control portion 302b, the communication portion 303, and the timer 308, respectively, of the slave reception device 201b.

In addition to the operations as performed by the communication portion 303, the communication portion 303c performs packet communication with the modem 602 according to MAC layer standards. When communicating with the master reception device 201a via the communication portion 303c, the control portion 302c confirms whether the communication destination has the MAC address AD stored in the address storage portion 310. When the control portion 302c is out of communication with the communication destination (the master reception device 201a) having the MAC address AD, the control portion 302c communicates with the time server 603 via the modem 602 to acquire information regarding time at which communication with the master reception device 201a was disconnected.

Based on the acquired time information, the control portion 302c stores communication disconnection time T_{b} at which communication with the master reception device 201a was disconnected to the time information storage portion 708. Furthermore, the control portion 302c periodically acquires a current time T_{c} from the time server 603. Thereafter, when the difference (ΔT=T_{c}−T_{b}) between the current time T_{c} and the communication disconnection time T_{b} stored in the time information storage portion 708 reaches a predetermined value (hereinafter, a “predetermined disconnection time Tₚ₂”) (ΔT≧Tₚ₂), the control portion 302c suspends the tuner 301.

When the control portion 302c has confirmed communication with the master reception device 201a while acquiring the current time T_{c}, the control portion 302c discards the communication disconnection time T_{b} stored in the time information storage portion 708.

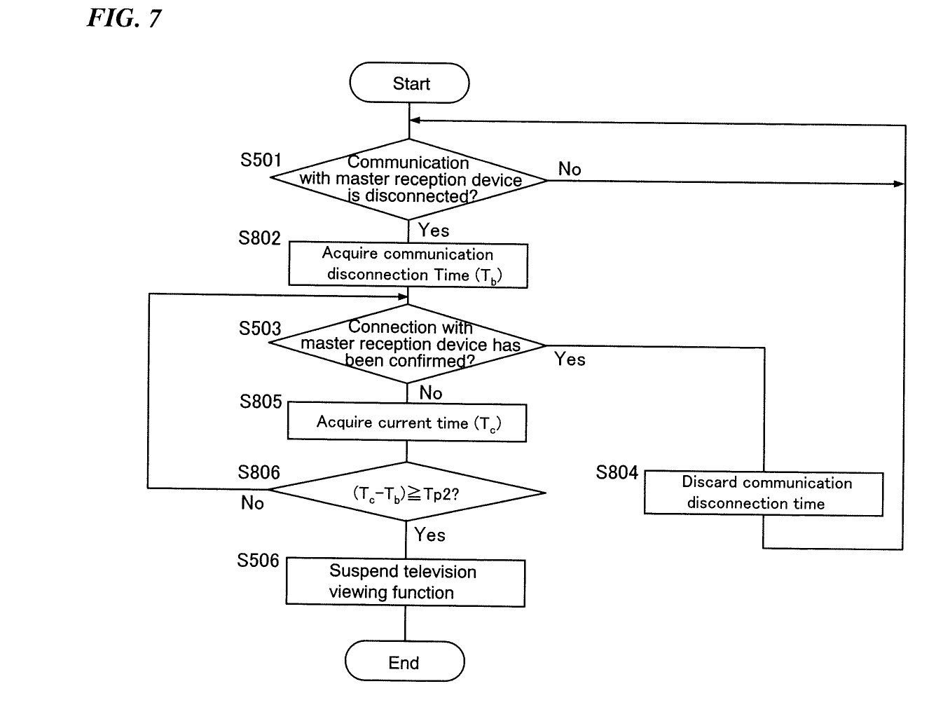

Next, referring to FIG. 7, control by the slave reception device 201c installed in the non-subscriber house 402 will be described, mainly focusing on the control operation unique to the control portion 302c. FIG. 7 illustrates a flowchart in which step S802, step S804, and steps S805 and S806 are substituted for step S502, step S504, and step S505, respectively, in the flowchart shown in FIG. 4.

When the slave reception device 201c is turned on to start operating, first, in step S501, it is confirmed whether communication between the slave reception device 201c and the master reception device 201a is disconnected. If the disconnection is confirmed, control advances to step S802.

In step S802, the communication disconnection time T_{b} at which the communication with the master reception device 201a was disconnected is acquired from the time information server 603. Then, in step S503, a determination is made, regarding whether the slave reception device 201c and the master reception device 201a are connected, i.e., the communication between the slave reception device 201c and the master reception device 201a is established. If it is confirmed that the communication is established, control advances to step S804.

In step S804, the communication disconnection time T_{b} is discarded. Then, control returns to the above step S501. On the other hand, if it is not confirmed in step S503 that the communication is established, control advances to step S805.

In step S805, the current time T_{c} is acquired from the time information server 603. Then, control advances to the next step S806.

In step S806, a determination is made, regarding whether the difference ΔT(T_{c}−T_{b}) between the current time T_{c} and the communication disconnection time T_{b} has reached the predetermined value Tₚ₂. If the difference ΔT has not yet reached the predetermined value Tₚ₂, control returns to the above step S503 to keep monitoring whether the communication with the master reception device 201a is established. On the other hand, if the difference ΔT has already reached the predetermined value Tₚ₂, in step S506, the control portion 302c suspends the tuner 301, thereby suspending the television viewing function. Thus, control is terminated.

As described above, even in the case of the slave reception device 201c, which does not have the timer 308 unlike the slave reception device 201b, when the master reception device 201a is turned off, the cable television broadcasting can be viewed for a predetermined period of time (Tₚ₂) as in the case of the slave reception device 201b. Furthermore, in the case where the slave reception device 201c is installed outside the subscriber's house, for example, it is possible to suspend the television viewing function after the predetermined period of time (Tₚ₂), thereby preventing unfair use.

In the present embodiment, the slave reception device 201c repeatedly acquires the current time T_{c} from the information server 603 after the time at which the connection with the master reception device 201a was disconnected (No in step S503). However, the slave reception device 201c may acquire the current time T_{c} from the time information server 603, for example, at the time of power on.

The means for the slave reception device 201b or 201c to communicate with the master reception device 201a may be a wireless LAN standardized by IEEE802.11, or a communication means employing a wireless technology, such as Bluetooth, infrared wireless communication, or specified low power radio. In addition, wired communication may be employed, and may not be limited to a LAN standardized by IEEE802.3.

The means for the slave reception device 201b or 201c to confirm the master reception device 201a is not limited to the MAC address AD of the master reception device 201a. For example, information for uniquely identifying the master reception device 201a, as typified by IP address, device ID, and password, can be used.

The broadcast network for connecting the slave reception device 201b or 201c to the master reception device 201a is not limited to the cable television network 10. For example, terrestrial/satellite airwave networks for providing the broadcast data DB on airwaves, and internet networks for providing the broadcast data DB via the Internet can be used.

In the case where a predetermined period of time (Tₚ₁ or Tₚ₂) has passed after the slave reception device 201b or 201c failed to confirm the communication with the master reception device 201a, so that the function of receiving the cable television broadcasting is suspended, when the communication with the master reception device 201a is established, the reception function may be activated by the user entering a password. Furthermore, the message “Please call a service man at the cable television broadcast station.” may be displayed without activating the function of receiving the cable television broadcasting.

The present invention is applicable to reception control not only of the cable television broadcasting but also of television broadcasting employing airwaves or internet networks.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A television reception control system, comprising:
a master reception device; and
a slave reception device,
wherein the master reception device is connected to a cable television network and an in-home network so as to receive and play back broadcast data transmitted from a cable television broadcast station via the cable television network, and communicate with the slave reception device via the in-home network, and
wherein the slave reception device is connected to the cable television network and the in-home network so as to receive and play back the broadcast data transmitted from the cable television broadcast station via the cable television network, and communicate with the master reception device via the in-home network, and when no communication with the master reception device is established, the slave reception device is suspended from receiving the broadcast data.

2. The television reception control system according to claim 1, wherein the slave reception device is suspended from receiving the broadcast data when no communication with the master reception device is established before a predetermined time lapse since a failure to confirm the communication with the master reception device.

3. The television reception control system according to claim 2,
wherein the slave reception device includes:
a communication unit for confirming the communication with the master reception device via the in-home network;
a timer unit for measuring elapsed time;
a tuner unit for receiving the broadcast data from the cable television network;
a decoder unit for decoding the received broadcast data to display video; and
a first control unit for (i) causing the tuner unit to transfer the broadcast data to the decoder unit, (ii) causing the timer unit to start measuring the elapsed time when the communication unit has failed to confirm the communication with the master reception device, (iii) causing the timer unit to stop measuring the elapsed time when the communication is confirmed, and (iv) causing the timer unit to stop functioning when the elapsed time being measured has reached a first predetermined time period.

4. The television reception control system according to claim 2,
wherein the in-home network is connected to an internet network, and
wherein the slave reception device includes:
a tuner unit for receiving the broadcast data from the cable television network;
a decoder unit for decoding the received broadcast data to display video; and
a communication unit for confirming the communication with the master reception device via the in-home network, and acquiring a current time based on time information outputted from a time information server connected to the internet network; and
a second control unit for (i) causing the tuner unit to transfer the broadcast data to the decoder unit, (ii) storing a communication disconnection time from the time server, which indicates a time of the failure to communicate with the master reception device, to a time information storage unit via the communication unit when the communication unit has failed to confirm the communication with the master reception device, (iii) acquiring the current time based on the time information outputted from the time information server via the communication unit every predetermined time period, and (iv) causing the tuner unit to stop functioning when a difference between the current time and the communication disconnection time has reached a second predetermined time period.

5. The television reception control system according to claim 1, wherein the in-home network is a LAN standardized by IEEE802.3, a wireless LAN standardized by IEEE802.11, or a communication means employing any one of the following: Bluetooth, infrared wireless communication, and specified low power radio.

6. The television reception control system according to claim 1, wherein the slave reception device recognizes the master reception device via the in-home network based on an address or a device ID owned by the master reception device or a password commonly owned by the slave reception device and the master reception device.

7. The television reception control system according to claim 1, wherein after the slave reception device is suspended from receiving the broadcast data, when the communication with the master reception device is established, the suspension on the slave reception device from receiving the broadcast data is lifted.

8. The television reception control system according to claim 7, wherein after the slave reception device is suspended from receiving the broadcast data, when the communication with the master reception device is established, the suspension on the slave reception device from receiving the broadcast data is lifted based on input of a preset password.

9. The television reception control system according to claim 4, wherein the slave reception device acquires the current time from the time information server at the time of power on.
